(19) United States
(12) Patent Application Publication
(10) Pub. No.: US 2022/0221877 A1
(43) Pub. Date: Jul. 14, 2022

(54) METHOD FOR MANAGING FLEETS OF SELF-GUIDED AGRICULTURAL VEHICLES

(71) Applicant: Agreenculture, Toulouse (FR)

(72) Inventors: Emmanuel Goua-de-Baix, Ramonville Saint Agne (FR); Clément Baron, Ramonville Saint Agne (FR)

(21) Appl. No.: 17/608,063

(22) PCT Filed: May 4, 2020
(86) PCT No.: PCT/FR2020/050740

§ 371 Date: Jan. 3, 2022

(30) Foreign Application Priority Data
May 2, 2019 (FR) 1904637

(51) Int. Cl. G05D 1/02; G07C 5/02; G07C 5/00; A01B 69/04

(52) U.S. Cl. CPC G05D 1/0297; G05D 1/0274; G05D 2201/0201; G07C 5/008; A01B 69/008; G07C 5/02

(57) ABSTRACT

A method for managing a fleet of self-guided agricultural vehicles, each having a means for the real-time determination of the coordinates of its current position, the method comprising calculating a digital map containing: at least georeferenced border data for the area of movement and a plurality of georeferenced indexed lines Lᵢ; and transmitting allocation messages for at least one indexed line Li to each of the self-guided agricultural vehicles. At least one copy of the digital map is stored in a digital memory of each of the agricultural vehicles. The movement of the agricultural vehicles is controlled on the basis of the allocated indexed lines Lᵢ and the position coordinates. The allocation messages for a following indexed line Lᵢ are transmitted to a self-guided agricultural vehicle when it transmits a service message.

### CROSS-REFERENCE TO RELATED APPLICATIONS

This application is a national phase entry under 35 U.S.C. § 371 of International Patent Application PCT/FR2020/050740, filed May 4, 2020, designating the United States of America and published as International Patent Publication WO 2020/221981 A1 on Nov. 5, 2020, which claims the benefit under Article 8 of the Patent Cooperation Treaty to French Patent Application Serial No. 1904637, filed May 2, 2019.

### TECHNICAL FIELD

The present disclosure relates to the field of self-guided agricultural vehicles, and, in particular, a fleet of self-guided agricultural vehicles and a system capable of performing a plurality of operations related to agriculture, and, in particular, for row crops.

### BACKGROUND

The development of geolocation technologies makes it possible to steer tractors, combine harvesters and other agricultural vehicles using guidance devices in order to partially eliminate the drudgery of working in the fields, increase productivity and reduce costs in all activities. These self-guided agricultural vehicles have many advantages and, in particular, allow:
the removal of overlaps and forgotten surfaces,
fuel, time and cost savings,
a reduction in the wear of the active area of the working parts of tools and/or machines,
reduced soil compaction, owing to a reduced number of passes,
control of farm traffic, and
better establishment of harvests.

Most of the known guidance devices use navigation based on a satellite positioning system, also referred to by the abbreviation GNSS (for Global Navigation Satellite System), such as GPS (Global Positioning System).

Crops of all types, whether fruit, vegetable or cereal crops or vines, require many operations such as weeding, plowing, sowing, hoeing, cutting, mowing and spraying.

The disclosure relates more particularly to the self-guiding of fleets of self-guided agricultural vehicles moving in collaboration on the surface to be worked according to predefined lines. These vehicles can thus be lighter, more agile and faster.

For the purposes of this disclosure, the term “line” is understood to mean a continuous closed or open path capable of being traveled by one of the agricultural vehicles (guide line) and/or traversed by a working element of the tool of the agricultural vehicle (working line). The topology of the lines is calculated prior to the implementation of the present disclosure.

For row crops, for example, corn or sunflower, each row of crops corresponds to a working line.

For perennial crops, for example, orchards or vines, each row and each inter-row of crops corresponds to a working line, each inter-row constituting a guide line for a non-straddle machine.

For perennial crops with straddle machines, for example, nurseries or vines, each row corresponds to a guide line.

For other crops, for example, wheat, the working surface is crossed by the guide lines forming a complete cover, taking into account the width of the work tool.

Patent application US2018/364726 is known in the state of the art, describing a control system for an agricultural work vehicle system comprising a controller with a memory and a processor, the controller being configured to:
Determine multiple partitions based, at least in part, on a map of an agricultural field;
Determine a partition list of multiple partitions based, at least in part, on a set of bounding characteristics of each of the multiple partitions;
Determine an order of the multiple partitions based on the partition list of the multiple partitions; and
Output a signal indicative of a travel path for the agricultural work vehicle.

This solution is not satisfactory for several reasons. First of all, it requires continuous exchanges, with high speeds, between the autonomous vehicle and the server when it is the server that controls one or more robots, or a significant computing power for the computer of the autonomous vehicle, as well as a communication capacity between the autonomous vehicles to coordinate their movements.

In a growing area, the radio communication conditions are not always of high quality, and the fact that the server allows the operator to “remotely control” certain functions of the work vehicle (for example, starting and stopping the work vehicle, asking the work vehicle to follow a route through the field, etc.) is a risk in the event of poor communication.

This solution is also based on partitioning the workspace, which does not make it possible to optimize the movements, since they are confined in a closed area with dimensions that are necessarily smaller than the dimensions of the total space to be processed. This solution, in particular, precludes several vehicles from working in the same partition.

Also known is patent application US2007/233745, which describes a method for creating a route plan for a group of agricultural machine systems and a corresponding route planning system. This prior art solution provides for networking the different route planning systems and for continuously exchanging data in order to individually determine routes for the individual machine systems, the routes of the respective other vehicles being taken into account in the optimization strategy. This solution implies that all machine systems then know where they are and where the other machine systems are.

Paragraph [0034], D2 specifies that “when a new machine system is added, it only needs to establish communication with the other machine systems and ‘announce’ itself within the group. It does this by transmitting its available route planning data that, in the simplest case, are its own position data, its machine parameters, and information about the fact that this machine system is supposed to participate in this operation. It then receives the route planning data from the other machine systems, including the existing route plan.”

This shows that each vehicle calculates its route and exchanges information with all the other vehicles, whereas the disclosure on the contrary exclusively provides for light communication between each of the vehicles and the supervisor.

### BRIEF SUMMARY

In order to address the drawbacks of the prior art, the present disclosure is based on the dissociation between:
a) the calculation of the topology of the area of movement, carried out by a computer separate from the computer of one of the autonomous vehicles, in particular, a supervisor or a server, performing the calculation processing of a digital map of the surface to be processed with a definition of travel lines, each associated with an identifier, without assigning lines to a particular autonomous vehicle at this stage; and
b) guidance, during movement on a line assigned to a vehicle, controlled by the computer of the vehicle in question, taking into account the digital map precalculated by the supervisor.

With this “macroscopic” distribution processed by the server, and microscopic distribution processed by the computer of each of the vehicles, it is possible to reduce the flow of data exchanged between the server of each of the autonomous vehicles and to improve the robustness of the system even in case of radio communications failure. These exchanges are limited to the transmission by the vehicle of a short message to signal its imminent arrival at the end of the allocated line, and the transmission by the server of a brief message containing the identifier of the vehicle concerned and the allocation of a new line.

The disclosure claims a method successively providing for:
communicating the map to each of the autonomous machines at an initial stage;
sending, by the supervisor to each of the autonomous machines, information packets of low weight to indicate the new line to be traversed; and
calculating the differences between the geolocation and the position planned by the computer of the autonomous machine, and not by the supervisor.

To this end, the disclosure relates in its most general sense to a method of managing a fleet of self-guided agricultural vehicles each comprising a means for the real-time determination of the coordinates of its current position, the method comprising:
calculating a digital map comprising:
   at least georeferenced border data for the area of movement;
   and a plurality of georeferenced indexed lines Lᵢ,
Transmitting allocation messages for at least one indexed line Lᵢ to each of the self-guided agricultural vehicles characterized in that:
   the method comprises an initial step of storing at least one copy of the digital map in a digital memory of each of the agricultural vehicles;
   the movement of each of the self-guided agricultural vehicles being controlled by a local computer on the basis of the allocated indexed lines Lᵢ and the position coordinates; and
   the allocation messages for a following indexed line Lᵢ being transmitted to a self-guided agricultural vehicles when and self-guided agricultural vehicle transmits a service message.

Advantageously, the digital map further comprises at least georeferenced data for at least one area to be worked constituted by a set of reference sections of at least one line or of a border of the area, the self-guided agricultural vehicles each comprise at least one work tool able to assume at least two states, the computer further controlling the state of the work tool as a function of the position coordinates and of the digital map. According to one variant, the digital map comprises at least one crossable area of interest constituted by a set of reference sections of at least one line or of a border of the area, and in that the local computer of the self-guided agricultural vehicle commands a change in the state of its work tool on the basis of the position coordinates and also of the georeferenced data of the border of the crossable area of interest.

According to another variant, the digital map comprises the areas of interest are indexed according to a type of work tool, and in that the fleet of self-guided agricultural vehicles is constituted by a heterogeneous set of self-guided agricultural vehicles associated with different work tools.

The high-level processing of determining the optimal line organization is performed on the central server. Precision monitoring processing of the allocated line is processed exclusively by the computer of each autonomous vehicle, without intervention on the server. Between the allocation of a new line and the arrival at the end of the line, the vehicle therefore operates completely autonomously, without requiring exchanges with the server. When it approaches the end of the allocated line, it sends a message containing its identifier. In the absence of a response from the server, the computer of the autonomous vehicle activates a safety procedure, for example, shutdown. If, on the contrary, the server transmits a message allocating a new line, the computer of the autonomous vehicle takes over control for monitoring the new line.

According to another variant, it comprises blocking or reserving the allocated lines, the step of transmitting the allocation messages excluding the lines belonging to the blocked or reserved lines.

According to another variant, the digital map further comprises at least georeferenced border data of at least one indexed maintenance area, the movement of each of the self-guided agricultural vehicles being controlled by a local computer on the basis of the indexed maintenance area allocated in response to a service message and the position coordinates.

According to another variant, the service message is transmitted by the self-guided agricultural vehicles when it approaches the end of the allocated line, and comprises current coordinates.

According to another variant, the service message comprising the current coordinates of the vehicle is transmitted periodically by each of the self-guided agricultural vehicles.

Advantageously, the self-guided agricultural vehicles periodically exchange the messages and recalculate the line and/or area allocations of each of the self-guided agricultural vehicles.

According to one variant, the method comprises steps of recording data packets comprising the current position transmitted by the local computer as well as the state of the work tools, and of periodically transmitting the data packets to a remote server.

According to another variant, the self-guided agricultural vehicles comprise means for detecting areas of interest and for transmitting georeferenced data for a detected area of interest in order to recalculate the digital map.

According to another variant, the local computer of each of the self-guided agricultural vehicles controls stopping if crossing of a border is detected.

According to another variant, it comprises steps of dynamically changing the crossable areas into non-crossable areas when all the lines opening into the area have been worked.

According to another variant, it comprises steps for transmitting georeferenced data for an area of interest detected by a third-party device, for the recalculation of the digital map.

According to another variant, it comprises steps of dynamically changing the crossable areas into non-crossable areas when all the lines opening into the area have been worked.

The disclosure also relates to a self-guided agricultural vehicle comprising a means for determining the coordinates of its current position in real time, and a digital memory for recording a digital map transmitted by a third-party device, the digital map comprising:
at least georeferenced border data of the area of movement; and
a plurality of georeferenced indexed lines Ri, wherein the self-guided agricultural vehicle comprises a computer for controlling the movement in real time on the basis of the digital map recorded in the memory, an allocation message of at least one indexed line Li received from a third-party device, and the position coordinates, the computer being further configured to control the transmission of a service message to at least one third-party device, to trigger the transmission by a third-party device of a new allocation message of a following indexed line Ri.

### BRIEF DESCRIPTION OF THE DRAWINGS

The present disclosure will be better understood upon reading the detailed description of a non-limiting example of embodiments of the disclosure that follows, with reference to the accompanying drawings, where:

FIG. 1 shows a schematic view of a system according to embodiments of the disclosure;

FIG. 2 illustrates a layer for calculating a digital map;

FIG. 3 illustrates a layer for calculating a digital map;

FIG. 4 illustrates a layer for calculating a digital map; and

FIG. 5 shows a schematic view of the path of an agricultural machine.

### DETAILED DESCRIPTION

The system according to the disclosure illustrated in FIG. 1 relates to working an area organized into a plurality of lines (2) with, at the end of the lines (2), turning areas (3, 4) located between the cultivable area and the movement boundaries of the agricultural machinery defined by the roadways, ditches, hedges and embankments bordering the area to be cultivated. The plot of land for cultivation structured in lines oriented so as to reduce maneuvers. The interval between two adjacent lines is generally constant, but may present variations locally to take account of specific features of the terrain. These lines are straight as far as possible, but may present curvatures locally. They define the passage lines for the agricultural machinery, for work such as plowing, sowing, weeding, harvesting, spraying various compounds, etc.

The topology of the plot is calculated by a server (5), separate from the computer and the equipment of one of the autonomous vehicles, by optimization processing operations and recorded in a memory (6) of the server in the form of a digital map comprising geolocated information relating to the lines (2) and the turning areas (3, 4). The server can be fixed equipment, or mobile equipment installed near the work area, for example, a van comprising a computer system, radio communication means (7, 8) and a power supply.

The system also comprises autonomous machines or agricultural vehicles (100) towing a work hitch (120). Each of the autonomous agricultural vehicles (100) is equipped with its own geolocation means (110), for example, by a satellite geolocation system (200).

A planner calculates the allocation of tasks for each machine and, particularly, the movement paths of each of the autonomous machines (100), and transmits the necessary information to the autonomous machines (100) to ensure that the allocated trajectory is followed according to the geolocation data received locally by each of the machines.

The path on the parcel is calculated based on the allocated line.

### Description of a Detailed Example of a Corn Row Crop

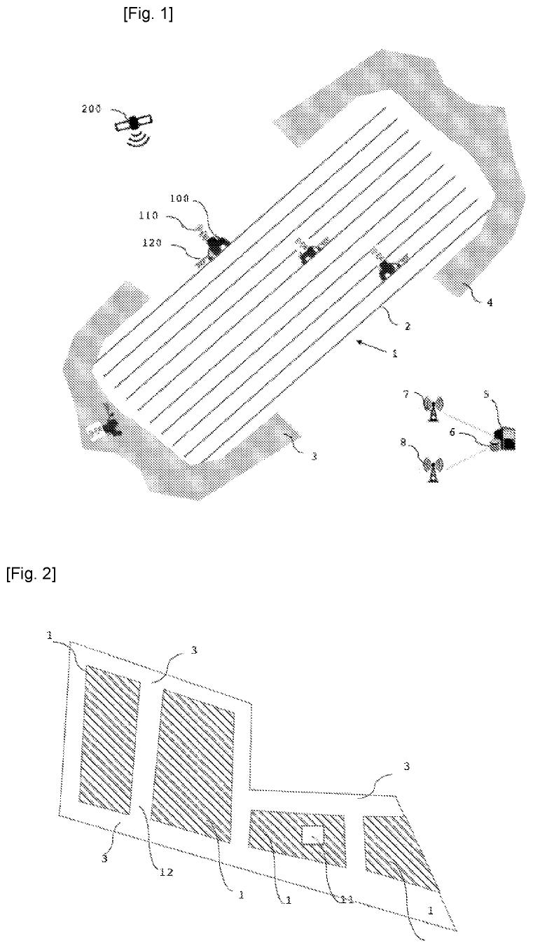

This example relates to the implementation of the disclosure to sow a corn field having an area to be sown (1) in a striped pattern in FIG. 2, with headlands or turning areas (3) on the periphery used consecutively to maneuver the machines, then for sowing, as well as non-passable obstacles (11), for example, a wind turbine, and crossable areas (12) that must not be seeded, for example, pathways or passages for irrigation pipes.

This information is precomputed upstream of the method according to the disclosure and recorded in the form of a first digital layer.

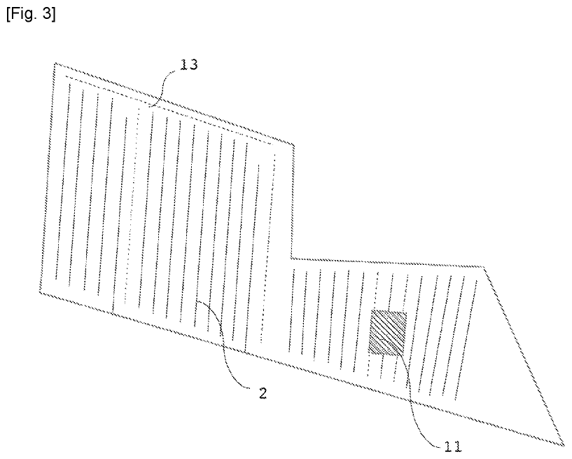

The initial data comprises a second layer illustrated by FIG. 3, presenting a set of lines, comprising lines (2) corresponding to the area to be sown (1) as well as lines (13) corresponding to the movement lines in the crossable areas (12).

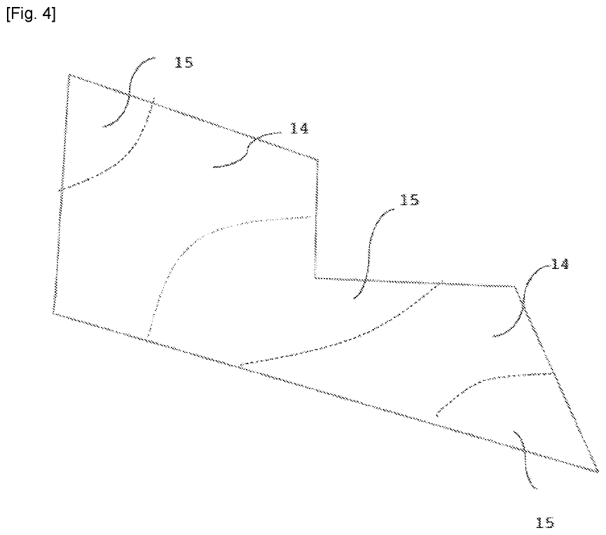

A third layer illustrated by FIG. 4 shows areas (14, 15) differentiated according to the recommendation map. For example, for a sowing, certain areas (14) require a dense sowing, and the value associated with this area will, for example, be 100,000 vines per hectare, while the less fertile areas (15) only require 85,000 vines per hectare.

Each of the layers is georeferenced to allow comparison with a digital geographic map as well as with any other topographic information.

These digital layers are downloaded either directly into the on-board memory of each of the agricultural vehicles, or transmitted to a planner carrying out pre-processing and then transmitting a digital map resulting from this processing to each of the autonomous agricultural vehicles.

When the fleet of autonomous agricultural vehicles (100) is installed on the field, each one receives a message from the planner allocating lines to be traveled and/or lines to be worked, in the form of a reference to the digital objects of the locally recorded digital map.

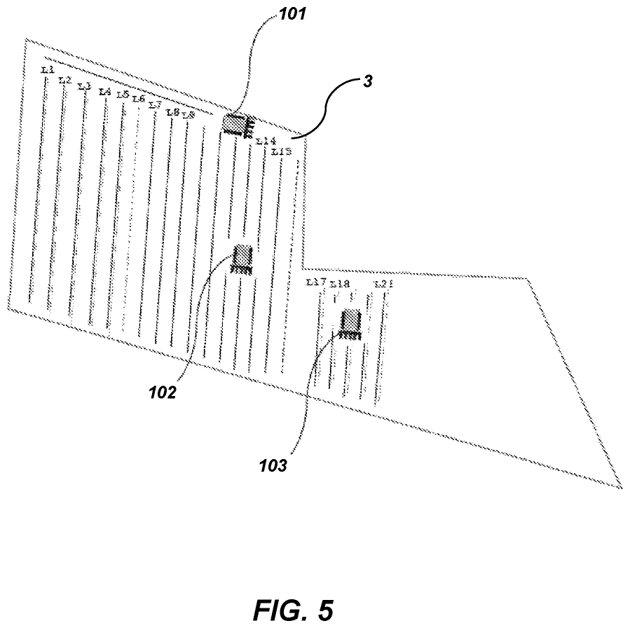

For example, the first robot or autonomous agricultural vehicle (100) is initially placed on a headland or turning area (3) as shown in FIG. 5. In the local memory of this first autonomous agricultural vehicle (100), first the digital map is recorded resulting from the various aforementioned layers, as well as the allocated lines, for example, a maneuvering line (LM1) and a set of consecutive lines (L1 to L5), for a robot working on five rows, with the center line L3 constituting the reference for guiding the movement of the first agricultural vehicle (100).

According to a first option, the lines initially allocated are limited to a length of the area to be worked. When the agricultural vehicle (100) approaches the end of this length, the planner sends it a new line set allocation message for the next length. To this end, the agricultural vehicle (100) periodically transmits a digital message comprising its identifier and the position resulting from the on-board geolocation means, as well as an acknowledgment of the instructions carried out.

According to another option, the planner transmits a plurality of allocation sets, allowing the agricultural vehicle (100) to process a succession of lengths interconnected by maneuvering lines (LM1).

According to a secure embodiment, the messages exchanged between each of the robots and the planner are encrypted, and possibly end-to-end encrypted. Advantageously, the data transmitted and the data received by the planner are recorded in a time-stamped manner.

In particular, the data can be injected into a node of a blockchain so as to guarantee convincing traceability of the work carried out by each of the agricultural vehicles.

In certain parts of the field, near a crossable area (12), for example, a part of an irrigation path encroaching on a line L5, the section T5 of line crossing this crossable area (12) is associated with an instruction interrupting the work of the corresponding tool (the other tools corresponding to lines L1 to L4 remaining active).

The control and guidance of the agricultural vehicle (100) are provided only by the on-board computer and the local geolocation data coming from the geolocation means specific to the agricultural vehicle (100).

The computer of the agricultural vehicle (100) modifies the movement direction commands on the basis of the lateral deviations measured with respect to the guide line L3 and/or with respect to the working lines L1 to L5.

The tools of the agricultural vehicle (100) are controlled on the basis of the data of the layer corresponding to the recommendation map and of the local geolocation data.

To improve work precision, the computer transmits the immediate setpoint value to the tool control circuit, as well as at least one future value. The control circuit can thus optimize the control of the tool to take account of the state change dynamics of the tool.

The work is carried out by a flotilla of agricultural vehicles (101, 102, 103), some of which can carry tools of different types and/or of different widths.

The planner assigns each of these agricultural vehicles (101 to 103) dedicated allocation messages, calculated so as to avoid intersecting paths and to optimize the processing of the field.

In the case where the allocation messages are limited to an area reserved for the same agricultural vehicle (100), defined by the lines limited to a length, or to the lines contained within a delimited area, the local computer will order the stopping of the agricultural vehicle (100) before the end of the reserved area if communication with the planner is lost.

In the case where the planner receives a service message from an agricultural vehicle (100) corresponding to an end of autonomy (for example, calculated by the planner on the basis of the residual autonomy communicated by the agricultural vehicle (100) and the distance to be covered over the following length), it calculates a return path for this agricultural vehicle (100) to a maintenance area. The messages recorded in the memory of the agricultural vehicle (100) at the end of its autonomy are then replaced.

The planner also recalculates new allocation messages to the agricultural vehicles (100) that remain operational based on the removal of the agricultural vehicle (100).

Optionally, the planner occasionally communicates state change messages for the areas; for example, when the entire area to be cultivated has been treated, the maneuvering areas become cultivable areas. The message transmitted by the planner is processed by the computer of each agricultural vehicle (100) to modify the digital layer in order to take into account the state change of certain areas.

### Distributed Planner

According to an alternative embodiment, the centralized planner is replaced by a distributed solution where the local computers of each of the agricultural vehicles (100) exchange task allocation negotiation messages. Each computer can, for example, record the allocation table specific to the vehicle in question, as well as the allocation tables of the other vehicles, and performs a check for the absence of overlap.

1. A method of managing a fleet of self-guided agricultural vehicles, each comprising a device for real-time determination of coordinates of its current position, the method comprising:
calculating a digital map including at least georeferenced border data of area of movement and a plurality of georeferenced indexed lines Lᵢ;
transmitting allocation messages for at least one indexed line Lᵢ to each of the self-guided agricultural vehicles Lᵢ, wherein:
the method comprises an initial step of storing at least one copy of the digital map in a digital memory of each of the self-guided agricultural vehicles;
the area of movement of each of the self-guided agricultural vehicles is controlled by a local computer on a basis of the allocated indexed lines Lᵢ and the position coordinates; and
the allocation messages for a following indexed line Lᵢ is transmitted to a self-guided agricultural vehicle when the self-guided agricultural vehicle transmits a service message.

2. The method of claim 1, wherein the digital map further comprises at least georeferenced data for at least one area to be worked constituted by a set of reference sections of at least one line or of a border of the area, and wherein the self-guided agricultural vehicles each comprise at least one work tool able to assume at least two states, the local computer further controlling the state of the at least one work tool as a function of the position coordinates and of the digital map.

3. The method of claim 2, wherein the digital map comprises at least one crossable area of interest constituted by a set of reference sections of at least one line or of a border of the area, and wherein the local computer of the self-guided agricultural vehicle commands a change in the state of its at least one work tool on the basis of the position coordinates and also of the georeferenced data of the border of the at least one crossable area of interest.

4. The method of claim 3, wherein the at least one crossable area of interest is indexed according to a type of work tool, and wherein the fleet of self-guided agricultural vehicles includes a heterogeneous set of self-guided agricultural vehicles associated with different work tools.

5. The method of claim 1, further comprising reserving the allocated indexed lines, and wherein the transmitting of the allocation messages excludes lines belonging to the reserved allocated indexed lines.

6. The method of claim 1, wherein the digital map further comprises at least georeferenced border data of at least one indexed maintenance area, and wherein the area of movement of each of the self-guided agricultural vehicles is controlled by a local computer on the basis of the indexed maintenance area allocated in response to a service message and the position coordinates.

7. The method of claim 1, wherein the service message is transmitted by the self-guided agricultural vehicles when they respectively approach an end of the reference section of the allocated indexed line, and the service message comprises current coordinates.

8. The method of claim 1, wherein the service message comprising the current position coordinates of each of the self-guided agricultural vehicles is transmitted periodically by each of the self-guided agricultural vehicles.

9. The method of claim 1, wherein the self-guided agricultural vehicles periodically exchange the allocation messages and recalculate line and/or zone allocations of each of the self-guided agricultural vehicles.

10. The method of claim 2, wherein the service message comprising the current position coordinates of each of the self-guided agricultural vehicles is transmitted periodically by each of the self-guided agricultural vehicles, the method further comprising recording data packets comprising the current position transmitted by the local computer as well as the state of the at least one work tool, and periodically transmitting the data packets to a remote server.

11. The method of claim 1, wherein the self-guided agricultural vehicles each comprise detecting system configured to detect areas of interest and to transmit georeferenced data for a detected area of interest to recalculate the digital map.

12. The method of claim 1, further comprising transmitting georeferenced data for an area of interest detected by a third-party device, for the recalculation of the digital map.

13. The method of claim 1, wherein the local computer of each of the self-guided agricultural vehicles controls stopping if crossing of a border is detected.

14. The method of claim 3, further comprising dynamically changing the at least one crossable area of interest into non-crossable areas.

15. A self-guided agricultural vehicle comprising a system configured to determine coordinates of its current position in real time, and a digital memory for recording a digital map transmitted by a third-party device, the digital map comprising:
at least georeferenced border data of area of movement; and
a plurality of georeferenced indexed lines Li,
wherein the self-guided agricultural vehicle comprises a computer for controlling the area of movement in real time on a basis of the digital map recorded in the digital memory, an allocation message of at least one indexed line Li received from a third-party device, and the position coordinates, the computer being further configured to control transmission of a service message to at least one third-party device, to trigger transmission by a third-party device of a new allocation message of a following indexed line Li.

16. The method of claim 2, wherein the self-guided agricultural vehicles periodically exchange the allocation messages and recalculate line and/or zone allocations of each of the self-guided agricultural vehicles, the method further comprising recording data packets comprising the current position transmitted by the local computer as well as the state of the at least one work tool, and periodically transmitting the data packets to a remote server.
